(19) United States
(12) Patent Application Publication
(10) Pub. No.: US 2016/0140641 A1
(43) Pub. Date: May 19, 2016

(54) Customized Shopping

(71) Applicant: Intel Corporation, Santa Clara, CA (US)

(72) Inventors: Jim S. Baca, Corrales, NM (US); David Stanasolovich, Albuquerque, NM (US); Hong Li, El Dorado Hills, CA (US); Mark H. Price, Placitas, NM (US)

(21) Appl. No.: 14/941,816

(22) Filed: Nov. 16, 2015

Related U.S. Application Data
(63) Continuation of application No. 13/686,963, filed on Nov. 28, 2012.

(51) Int. Cl. G06Q 30/06; G06K 9/66

(52) U.S. Cl. CPC G06Q 30/0627; G06Q 30/0643; G06K 9/66

(57) ABSTRACT

An embodiment of the invention includes a network-accessible compute node, which includes a local storage storing reference images. Each reference image can depict one or more preferences, which can include a quality, a feature, a characteristic, an attribute, a type, and/or a form. Each preference can be associated with a distinctive pattern and a preference criterion. An embodiment includes an optimization module. The optimization module can learn the distinctive patterns from the reference images. The optimization module can also access a remote storage storing images of commodities and use pattern recognition to identify, from the remote storage, one or more images of commodities meeting the preference criterion selected by a user. Other embodiments are described and claimed.

### CROSS-REFERENCE TO RELATED APPLICATIONS

This is a continuation application based on non-provisional application Ser. No. 13/686,963, filed on Nov. 28, 2012, hereby expressly incorporated by reference herein.

### BACKGROUND

For many people, shopping is a time consuming and tedious task. It can be even more stressful if the shopper has a particular preference, such as a couch that will tie into his or her game room décor. To find the right couch, the shopper may have to go to several different stores and look at his or her options. The stores may be located some distance apart, and they may not carry couches having a primary feature that the shopper prefers. Furthermore, by the time the shopper has visited several different stores the shopper may not remember what the couches looked like at the beginning of the shopping experience. Thus, the shopper may have to revisit one or more stores.

Although online shopping may relieve some of the stressors associated with traditional shopping, it is not without its own frustrations. For instance, the shopper may have to visit several different web sites instead of different stores, and may still have the same problem of not remembering what he or she looked at early on in the shopping experience. And although the online shopper is not spending time driving around town, he or she can still consume a vast amount of time browsing online without finding a suitable solution. Thus, for many people shopping continues to be frustrating and not enjoyable.

### BRIEF DESCRIPTION OF THE DRAWINGS

Features and advantages of embodiments of the present invention will become apparent from the appended claims, the following detailed description of one or more example embodiments, and the corresponding figures, in which:

FIG. 1 includes a schematic block diagram in an embodiment of the invention.

FIG. 2 includes a flow chart for a process in an embodiment of the invention.

FIG. 3 includes another flow chart for a process in an embodiment of the invention.

FIG. 4 includes yet another flow chart for a process in an embodiment of the invention.

FIG. 5 includes a block diagram of a processor in an embodiment of the invention.

FIG. 6 includes a block diagram of a system for in an embodiment of the invention.

FIG. 7 includes a block diagram of system in an embodiment of the invention.

FIG. 8 includes a block diagram of functional components for use in an embodiment of the invention.

FIG. 9 includes a schematic illustrating how information can be displayed in an embodiment of the invention.

FIG. 10 includes a block diagram of a system layer structure for use in an embodiment of the invention.

### DETAILED DESCRIPTION

In the following description, numerous specific details are set forth but embodiments of the invention may be practiced without these specific details. Well-known circuits, structures, and techniques have not been shown in detail to avoid obscuring an understanding of this description. “An embodiment”, “various embodiments”, and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally or spatially, or in ranking, or in any other manner. “Connected” may indicate elements are in direct physical or electrical contact with each other and “coupled” may indicate elements co-operate or interact with each other, but they may or may not be in direct physical or electrical contact. Also, while similar or same numbers may be used to designate same or similar parts in different figures, doing so does not mean all figures including similar or same numbers constitute a single or same embodiment.

An embodiment of the invention provides a user of an electronic device with a customized shopping experience. For example, the user may use his or her electronic device to select criteria such as a commodity-type criterion and a preference criterion. In this way, the user may indicate the type of good, service, or both (e.g., commodity) in which the user is interested, and the preferred quality, feature, attribute, characteristic, form, or the like (e.g., preference) the good and/or service should possess. An embodiment of the invention may include learning distinctive preferences to facilitate identifying one or more commodities of an indicated type that have an indicated preference. Thus, an embodiment identifies goods, services, or both meeting the user's indicated needs, including a preference need, and provides information/images of the identified goods and/or services to the user. An embodiment may create a bundle or a collection including one or more identified commodities and another commodity. If the user desires, the user may purchase one or more identified commodities, a collection of commodities, a bundle of commodities, or combinations thereof. In an embodiment, the user may purchase a voucher or coupon for one or more identified commodities. In an embodiment, the user may book an appointment or place a commodity on hold. And an embodiment enable a user of the electronic device to negotiate for a discount to an originally offered price for an individual commodity, a collection of commodities, a bundle of commodities, and combinations thereof.

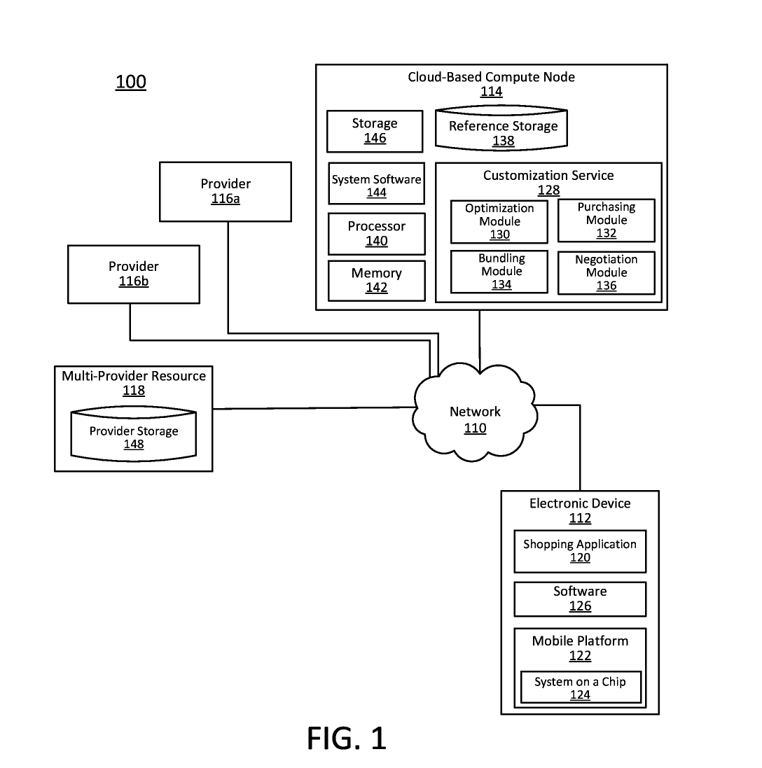

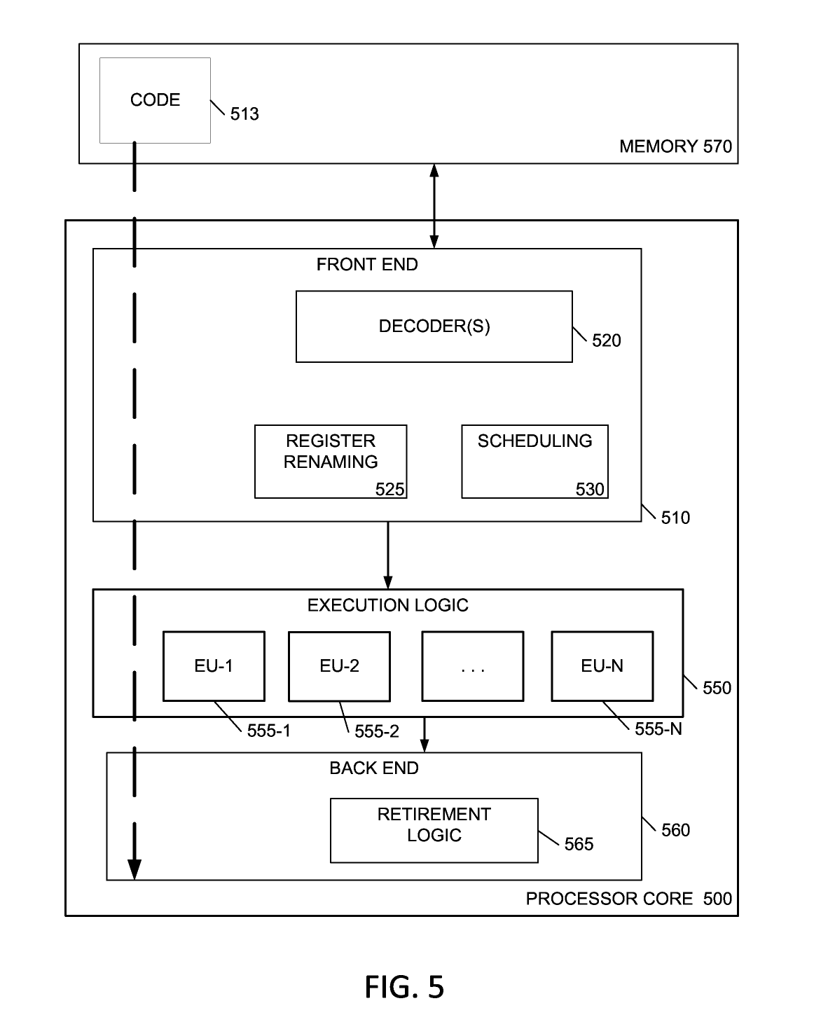

FIG. 1 includes an embodiment of a system 100 that may be used to implement customized shopping. The system 100 may include a network 110, an electronic device 112, a cloud-based compute node 114, one or more providers 116a, 116b, and a multi-provider resource 118. Generally, each of the electronic device 112, cloud-based compute node 114, providers 116a, 116b, and multi-provider resource 118 may include at least one compute node. See also FIGS. 5 through 10, below. For example, the electronic device 112 may be a portable or mobile device such as a mobile phone (e.g., smartphone), a tablet computer, a notebook computer, a personal digital assistant, and an e-reader as non-limiting examples. In an embodiment, the electronic device 112 may be a desktop computer or other suitable type of compute node that is not readily portable. The cloud-based compute node 114, in an embodiment, may be any type of compute node found in a data center or a hub, such as one or more servers and/or another computer system. The providers 116a, 116b and the multi-provider resource 118 may each have a compute node that is generally similar to the cloud-based compute node 114, the electronic device 112, or both. For example, in an embodiment, the providers 116a, 116b and the multi-provider resource 118 may each include one or more of a mobile device (e.g., mobile phone, tablet computer, notebook computer), a personal computer, and a server as a few examples. Furthermore, in an embodiment, the cloud-based compute node 114, the providers 116a, 116b, and the multi-provider resource 118 may each distribute storage and processing over multiple processors and compute nodes.

One or more of the electronic device 112, the cloud-based compute node 114, the providers 116a, 116b, and the multi-provider resource 118, may communicate via the network 110. The network 110 may be any type of network such as wired, wireless, or a combination thereof. Exemplary networks include an internet, Wi-Fi, wide area networks (e.g., WANs and wireless WANs), and local area networks (LANs and wireless LANs), as a few examples.

Referring to the electronic device 112, a shopping application 120 may be executed thereon to enable customized shopping. See, e.g., FIGS. 5 through 10, below. In an embodiment, the electronic device 112 may also include a general mobile platform 122, which may utilize a system-on-a chip 124. The electronic device 112 may include additional software 126 (and/or hardware, although not shown) to augment electronic device 112 functioning. See, e.g., FIGS. 5 through 10, below.

In an embodiment, the shopping application 120 may cooperate with a customization service 128, which may execute on the cloud-based compute node 114. See, e.g., FIG. 5, below. The customization service 128 may include one or more modules 130, 132, 134, and 136. Each module 130, 132, 134, and 136 may cooperate with one or more other modules 130, 132, 134, or 136 to contribute to an embodiment of customized shopping. The cloud-based compute node 114 may also include one or more processors 140 and/or memories 142, system software 144, storage 146, and additional components (not shown), which may facilitate execution of the customization service 128 and/or function of the cloud-based compute node 114. See, e.g., FIGS. 5 through 10, below. The storage 146 may be any type of storage including one or more disks such as hard disks, optical disks, and solid-state disks. The storage 146 may store the customization service 128 and/or additional files such as data files and program files. In an embodiment, a physical storage device (e.g., storage 146) may be partitioned or otherwise allocated to into different logical drives. For example, a reference storage 138 may be separated logically (or physically) from the storage 146. Thus, in an embodiment, the reference storage 138 and the storage 146 may or may not be included on the same physical storage device. Generally, the reference storage 138 may store reference images for different preferences. In an embodiment, the reference storage 138 includes a database of reference images.

Although FIG. 1 shows two providers 116a, 116b and one multi-provider resource 118, any number of providers and multi-provider resources may participate in the system 100. Furthermore, although the multi-provider resource 118 is shown as a separate entity, the multi-provider resource 118 may be associated with one or more other entities such as a cloud-based compute node (e.g., cloud-based compute node 114), one or more individual providers (e.g., providers 116a, 116b), and a network service provider (not shown).

Providers 116a, 116b may be providers of goods, services, or both. Exemplary providers 116a, 116b include stores, shops, salons, restaurants, real estate agents, brokers, fitness facilities, landscapers, architects, and any other provider of goods and/or services. Furthermore, providers 116a, 116b may have a physical presence (e.g., a brick-and-mortar), a virtual presence (e.g., a web site), or both. In an embodiment, providers 116a and/or 116b may subscribe to the multi-provider resource 118. And in an embodiment, there may be a multi-provider resource 118 for each type, or related types, of goods and/or services. For example, clothing providers may subscribe to one multi-provider resource 118 and salons (e.g., hair, nails, tanning) may subscribe to a different multi-provider resource 118. Embodiments, however, may include any other suitable arrangement such as subscribing to a region-specific (e.g., city, state, country, continent) multi-provider resource 118, or subscribing to a single, worldwide multi-provider resource 118 (which may be a distributed system).

As is shown in FIG. 1, the compute-node associated with the multi-provider resource 118 may include a provider storage 148 to store images of commodities offered by the providers 116a, 116b. In an embodiment, however, one or more of the providers 116a, 116b may maintain the provider storage 148. Moreover, in an embodiment, the provider storage 148 may be distributed among the compute nodes associated with the multi-provider resource 118 and the compute nodes associated with one or more of the providers 116a, 116b.

Each provider 116a, 116b may store multiple images of each good and/or service that it offers for sale in one or more provider storages 148. Ideally, the multiple images capture variations in preferences. For example, a clothing provider may provide multiple images of the same garment (e.g., suit jacket), each image capturing a different color (e.g., black, navy), pattern (e.g., striped, color block), and/or other variation (e.g., material). As another non-limiting example, a landscaping service may provide multiple images of a water feature, each image capturing a different size (e.g., small, medium, large, extra large), material (e.g., plastic, fiberglass, concrete), special purpose (e.g., koi pond, lily pond), and/or other variation. In an embodiment, the provider storage 148 may be a database, and it may or may not be provided on a physical device that serves other storage needs.

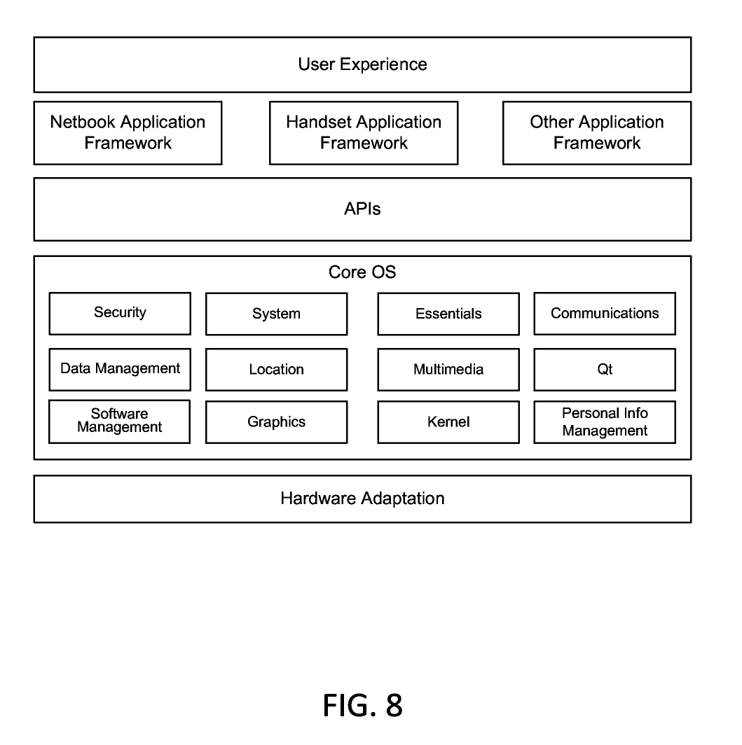

To customize his or her shopping experience, the user may operate the electronic device 112 to select customization criteria. See, e.g., FIGS. 8, 9, and 10, below. For example, the user may select customization criteria using one or more selection techniques such as lists, hierarchies, menu objects, radio buttons, icons/graphic elements, voice command, entering data in a field, and the like. Furthermore, customization criteria may be selected at any level of specificity including generic criteria (e.g., shirt, flowering plant) and/or criteria that are more specific (e.g., Rugby shirt, rose). In an embodiment, the shopping application 120 may be used alone or in combination with another application (e.g., browser, customization service 128) to facilitate user selection of customization criteria and/or other aspects to customize shopping. And in an embodiment, thumbnail pictures and/or other information may be displayed on the electronic device 112 in connection with customization criteria. In this way, the user of the electronic device 112 may be provided with additional information about a particular customization criteria.

Customization criteria may include a wide variety of criteria, which embodiments may express in numerous ways. In an embodiment, two such criteria can include a commodity-type criterion and a preference criterion. Generally, a commodity may be a good or service. Goods include numerous types of goods such as clothing, electronics, furniture, decorations (e.g., home décor, yard décor), buildings (e.g., dwellings), as a few examples. Likewise, services include many types of service, which may or may not include goods, such as salons (e.g., hair, nail, tanning, bridal), yard services (e.g., lawn, landscaping), real estate agents, restaurants, fitness, and interior decorating as a few examples. Furthermore, the electronic device 112 user may select the commodity-type criterion at any level of specificity. Thus, the electronic device 112 user is not limited to the forgoing general examples.

The preference criterion may target a particular quality, feature, attribute, characteristic, type, form, or the like of a commodity. Thus, preference criteria may be characterized in many different ways; embodiments are not limited to a particular characterization scheme. Moreover, a given criterion may be a commodity-type criterion in some instances and a preference criterion in another instance. And a given criterion may be a preference criterion in some cases, but not in other cases. As non-limiting examples, a type of electronic device (e.g., smartphone) may be a commodity-type criterion and a preference criterion (e.g., for a commodity type of mobile phone), and a particular color (e.g., red) may be both preference criterion (e.g., for a commodity type of a hair salon service) and a color criterion (e.g., for a commodity type of a garment). In an embodiment, one or more preference criteria may be specific to a particular commodity. For example, fitness preferences may include martial arts, personal trainers, weight lifting, boot camp, cross training, yoga, Pilates, boxing, and the like. And there may be additional preferences associated with a particular fitness preference such as martial arts (e.g., taekwondo, judo, karate) and yoga (Ashtanga, Vinyasa, Bikram). Other preference criteria, however, may apply to several different types of commodities. For example, preferences such as modern, eclectic, ethnic, country/western, traditional, and the like may apply to several different types of commodities (e.g., clothing, buildings, restaurants, and/or furniture). Although embodiments are not limited, exemplary preference criteria may include fashion-based preferences (e.g., modern, ethnic, celebrity, western, traditional), celebrity-based preferences, architectural preferences (e.g., cottage, Victorian, modern, plantation, ranch, beach, gothic), building features (e.g., brick, wood, stucco, columns, porch, number and/or types of rooms, square feet), genre-based preferences (e.g., modern, rock, family, adventure), age-based preferences (e.g., children, tweens, teens, adults, seniors), restaurant types (e.g., fast food, family-style, pizzeria, pub, fine dining), cuisine (e.g., French, Italian, Chinese, Thai, South American, Mexican, burgers, vegetarian, barbeque), salon services (e.g., color, cut, hair types, men, children, blow-dry, straightening, permanents), types of electronics (e.g., ultrabooks, laptops, desktops computers, e-readers, mobile phones, servers), specifications (e.g., amount of memory, number and type of processors, display size, shape), landscape preferences (e.g., country/western, cottage, ethnic, tropical, desert, forest, native), landscape features (e.g., pools, arbors, beds, gardens, walkways, fire pits), and combinations thereof. As with the commodity-type criterion, the preference criterion may be selected at any level of specificity (e.g., ethnic, Asian, Chinese, Szechwan).

In an embodiment, the electronic device 112 user may create one or more personalized preferences such as “my preferences” as selectable preference criterion option. Generally, the user may supply reference pictures of the user's personalized preferences to the electronic device 112, the customization service 128, or both. Furthermore, the user may define a “universal” personalized preference, which may apply to plural commodities, or a personalized preference for one or more different types of commodities. The pictures depicting the user's personalized preferences may be stored on the electronic device 112, at the cloud-based compute node 114, or both.

The electronic device 112 user may also select other or additional customization criteria for a more refined level of customization. There may be a wide variety of customization criteria other than the commodity-type criterion and the preference criterion. And the other customization criteria may or may not be commodity or preference specific. As one non-limiting example of other or additional customization criteria, a user shopping for a shirt may also select customization criteria relating to one or more of color, size, price limit, best price, preferred provider, and number of results to return (e.g., 2, 3, 4, 5, 6, etc.). As another non-limiting example, a user looking for a place to eat may select other or additional criteria relating to one or more of price, portion size, location, awards, demerits, average wait time, number of results to return, and the like. Like the commodity-type criterion and the preference criterion, the user may select other or additional criteria at any level of specificity. Furthermore, what may be considered a preference criterion in one instance may be considered an additional or other criterion in another instance.

The user of the electronic device 112 may select a goal of customization or a customization priority in an embodiment of the invention. For example, if the electronic device 112 user selects several customization criteria, he or she may indicate which of the several criteria should have the highest priority (e.g., price limit criterion or preference criterion). Thus, customization may be further refined by giving the most weight to the highest priority customization criteria.

The electronic device 112 user may also use the electronic device 112 to view results returned from the customization service 128 and to make decisions relating to the returned results. Generally, the user may view images of commodities meeting customization criteria, information about such commodities, or both on the display of the electronic device 112. If interested, the electronic device 112 user may opt to purchase one or more of the commodities from the returned results. In an embodiment, the user may use the electronic device 112 to purchase a commodity online such as via the network 110 as is known in the art. In an embodiment, the user may purchase a commodity at a brick-and-mortar store or the like. Furthermore, the electronic device 112 user may make a partial payment (e.g., down payment, layaway) online and the remainder in person. Nevertheless, the electronic device 112 user may sample or try on the commodity before buying the commodity. For example, the electronic device 112 user may try on one or more clothing items either virtually or physically or both before purchasing a clothing item.

In an embodiment, the electronic device 112 user may purchase a coupon or voucher for the commodity and use the coupon or voucher when desired. And in an embodiment, the user may not make a purchase right away; rather, the electronic device 112 user may schedule an appointment, make a reservation, place a commodity on hold, or the like. An embodiment even contemplates the electronic device 112 user both making a purchase (e.g., commodity, coupon, voucher) and scheduling an appointment/making a reservation. As one non-limiting example, the user may use the electronic device 112 to purchase a coupon for hair salon services and/or to schedule an appointment for the salon services. As another non-limiting example, the user may use the electronic device 112 to schedule a fitting for a clothing item (e.g., suit, wedding gown) and/or put a down payment on the clothing item.

The electronic device 112 user may also use the electronic device 112 to consider a collection and/or a bundled offer returned to the electronic device 112 from the customization service 128. Generally, a collection is generated in response to user-selection of a “collection” customization criteria. A bundle, however, may be generated with or without user-selection of an specific “bundle” customization criteria. Furthermore, a collection or a bundle may include more than one commodity meeting the customization criteria, one or more commodities meeting the customization criteria paired with one or more complementary commodities, and other collection/bundling options. In an embodiment, one or more commodities in the collection or bundle may meet the preference criterion. Furthermore, the user may use the electronic device 112 to make a purchase, schedule an appointment, make a reservation, and/or place a hold, in connection with, or separately from, the collection or bundled offer.

The electronic device 112 user may also use the electronic device 112 to make a counteroffer to an original price provided with a purchase option (e.g., collection, individual commodity, bundle) in an embodiment. For example, the user may want to purchase a particular commodity, a collection, or a bundle of commodities, but at a lower price that what is initially offered. Thus, the user has the ability to make a counteroffer via the electronic device 112. Furthermore, the user may use the electronic device 112 to make a purchase, schedule an appointment, make a reservation, place a hold, and the like in connection with, or separately from, making a counteroffer.

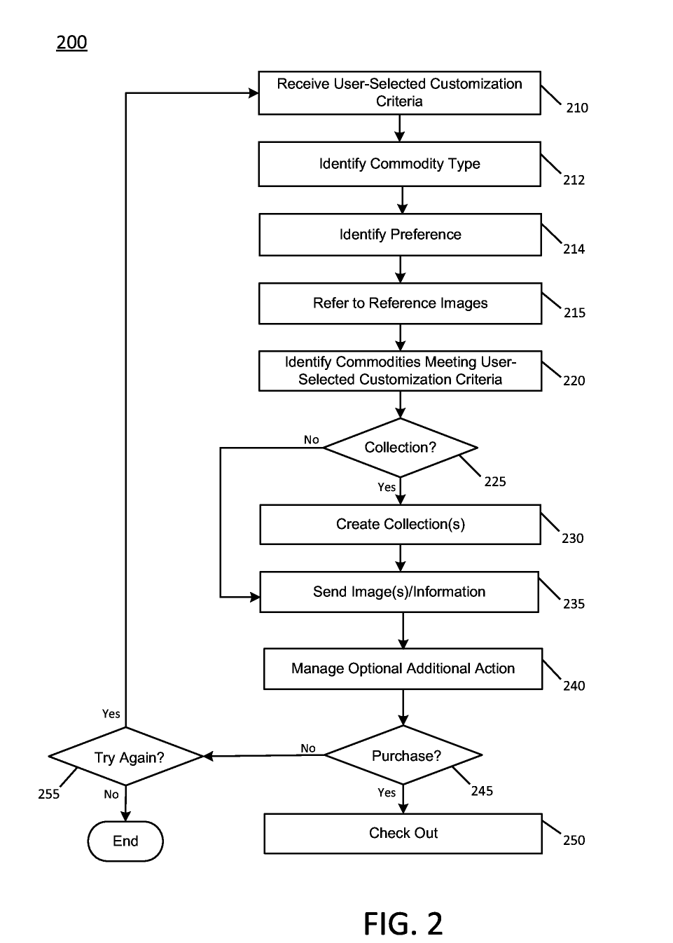

Referring to both FIG. 1 and FIG. 2, the customization service 128 may utilize an embodiment of a process 200. In an embodiment, however, the process 200 (or a portion thereof) may be utilized by another service, compute node (e.g., electronic device 112), or combinations thereof. Referring to block 210, the customization service 128 may receive the user-selected customization criteria from the electronic device 112. As one non-limiting example, the customization service 128 may receive the user-selected customization criteria (e.g., commodity-type criterion, preference criterion, other/additional criteria) via the network 110.

Referring to blocks 212 and 214, the customization service 128, such as via the optimization module 130, may identify the commodity type indicated by the user-selected commodity-type criterion and the preference indicated by the user-selected preference criterion. In an embodiment, the user may have selected more than one commodity-type criteria; thus, the customization service 128 (or module thereof) can identify the commodity-type associated with each selected commodity-type criteria. The user-selected preference criteria, however, may be the same or different for each identified commodity type. For example, the user may have selected two different types of clothing items (e.g., shirt, pants) as commodity-type criteria. The user may have selected the same preference criterion (e.g., to emulate a particular celebrity look) or different preference criteria (e.g., one to emulate a particular celebrity, the other western) for both clothing items. As another example, the user may have selected unrelated commodity-type criteria (e.g., restaurant, hair salon). Nevertheless, the user may have selected the same or similar preference criterion (e.g., modern, nouveau) even though the desired commodities are different types. Alternatively, the user may have selected different preference criteria (e.g., fast food, kids cuts) for each unrelated commodity.

In an embodiment, the optimization module 130 may respond to the identification of the preference associated with the user-selected preference criterion by referring to one or more reference images featuring the subject preference, as is indicated in block 215. The optimization module 130, however, is not required to refer to reference images in response to identifying a preference. For example, the optimization module 130 may have learned or update learning of various preferences during periods of low-usage; thus, the optimization module 130 may already know the preference indicated by the user-selected preference criterion and can proceed with an embodiment of the process 200.

Reference images or pictures may be stored in the reference storage 138. Ideally, one or more reference images are stored for each contemplated preference such as those corresponding to preference criteria. This ideal, however, may not always be the case and embodiments are not so limited. The reference storage 138 may also store one or more reference images featuring the user's personal preference or “my preferences.” In an embodiment, the user may use the electronic device 112 to supply reference images depicting his or her personal preferences in a manner known in the art. In another embodiment, the user may store images depicting personal preferences and/or other reference images on the electronic device 112. In yet another embodiment, reference pictures, including the user's personal preference pictures, may be stored at plural different locations such as the reference storage 138 and the electronic device 112.

The optimization module 130, customization service 128, another module of the customization service 128, or combinations thereof, may learn, update, and/or remember preferences via pattern recognition techniques. Generally, a pattern recognition algorithm may use reference images stored in the reference storage 138 (and/or electronic device 112) to enable machine learning such as pattern recognition. For example, reference images corresponding to a particular preference (e.g., ethnic, vintage, gothic, western, my preference, processor type, tropical, burgers, curly, straight, wood, mountain, etc.) may be used to train the optimization module 130 to recognize patterns that may help distinguish a particular preference. It should be noted that pattern recognition is not limited to recognizing an identical match. Thus, the optimization module 130 may use patterns learned from the one or more reference images to recognize/categorize the same or similar patterns found in images of commodities. Embodiments, however, are not limited to learned pattern recognition; in an embodiment, the optimization module 130 may be self-taught from commodity images. Furthermore, the optimization module 130 (trained and/or self-taught) may continue to learn such as by recognizing/classifying images of commodities. In an embodiment, a pattern recognition algorithm may include a hidden Markov Model; embodiments, however, are not limited to a particular algorithm or classification approach (e.g., statistical, structural, neural).

In block 220, the optimization module 130 may identify one or more commodities meeting the user-selected customization criteria. Generally, an embodiment enables the optimization module 130 to use one or more pattern recognition techniques to identify an image of a commodity meeting at least one user-selected customization criteria from the provider storage 148. For example, the optimization module 130 may identify an image, from the provider storage 148, that meets one or more of the user-selected commodity-type criterion (e.g., smartphone, single family home) and preference criterion (e.g., 3-D camera, or plantation, wrap-around-porch or both). Furthermore, if the user selected a customization priority, the optimization module 130 may place more weight on the customization criteria having the highest customization priority. For instance, if the user indicated that the preference criterion has the highest priority, then the optimization module 130 may give more weight to a preference criterion (e.g., 3-D camera, plantation, wrap-around-porch) than to other user-selected criteria when identifying images of commodities matching the user-selected customization criteria or after images of commodities have been identified and before sending information/images to the electronic device 112. See, e.g., block 235, below. In an embodiment, the optimization module 130 may access the provider storage 148 over the network 110.

An embodiment of the process 200 may include an option to create a collection, as is indicated in diamond 225. A collection may include two or more goods or two or more services. Alternatively, a collection may also include a combination of at least one good and at least one service. In an embodiment, the user may indicate that he or she is interested in a collection by selecting a customization criterion or similar type of user selection in a graphical user interface (GUI) displayed on the electronic device 112 display. The user may also indicate (e.g., via selecting a customization criteria) a number of collections that the optimization module 130 should return to the electronic device 112. The optimization module 130 may return a default number of collections if the user does not indicate a specific number of returns. Furthermore, the optimization module 130 may consider a user-selected customization priority when identifying suitable commodities from the provider storage 148, when generating collections, or both. If the user of the electronic device 112 selected a “create collection” option or the like, the process 200 may continue at block 230. If the user did not select such an option, the process 200 may continue at block 235.

In block 230, the optimization module 130 may use available information (e.g., customization criteria) to create one or more collections. In an embodiment, the optimization module 130 may create or generate a collection by joining, linking, or otherwise associating information and/or images of commodities identified from the provider storage 148 as meeting the user-selected customization criteria. For example, the optimization module 130 may form a collection by associating suitable information and/or identified images of goods, services, or goods and services. As one non-limiting example, if the user is shopping for an outfit (e.g., collection), the user may select a shirt and pants as commodity-type criteria and business-casual as a preference criterion. The shirt and pants, however, may each be associated with a different preference criteria such as Hawaiian and business-casual, respectively. The optimization module 130 may join or link information and/or images of commodities (e.g., Hawaiian shirts and business-casual pants) identified from the provider storage 148 to create or generate one or more outfits (e.g., collections) meeting the user-selected criteria. As another non-limiting example, the user may want to buy a plantation (e.g., preference criterion) home (e.g., commodity-type criterion) and may want to find an interior decorator (e.g., commodity-type criterion) that specializes in tropical (e.g., preference criterion) designs. The optimization module 130 may associate information and/or images of plantation homes and specialized interior designers (e.g., commodities) identified from the provider storage 148 to provide one or more collections meeting the user's selected customization criteria. In another non-limiting example, the electronic device 112 user may want to find a hair stylist (e.g., commodity-type criterion) that specializes in trendy haircuts (e.g., preference criterion) and a nail technician (e.g., commodity-type criterion) who specializes in French manicures (e.g., preference type criterion). The optimization module 130 may associate information and/or images of hair stylists and nail technicians (e.g., commodities) identified from the provider storage 148 to generate one or more collections meeting the user-selected preference criteria of trendy haircuts and French manicures.

In an embodiment, the optimization module 130 may create or generate a collection by joining, linking, or otherwise associating an image provided by the electronic device 112 user and one or more images (e.g., from the provider storage 148) of commodities that meet the user-selected criteria. For example, the user may want to pair pants that the user owns, or is considering buying, with another garment such as a shirt, jacket, or sweater. The user may upload a picture of the pants to the optimization module 130 and select shirt, jacket, and/or sweater as commodity-type criteria and sporty as a preference criteria. The user may also select other or additional customization criteria such as a collection criteria, and a user-provided image criteria to let the optimization module 130 know that he or she is interested in collections that include the pictured pants. Using at least this information, the optimization module 130 may identify one or more images of commodities (e.g., shirt, jacket, sweater) from the provider storage 148 that meet the user-selected customization criteria. The optimization module 130 may pair one or more images of identified commodities (e.g., shirt, jacket, sweater) with the image of the pants provided by the user to generate a collection (e.g., outfit) meeting the user's customization criteria.

Referring to block 235, the cloud-based compute node 114 (e.g., via optimization module 130 or another module) may transmit information and/or a commodity image to the electronic device 112. The transmitted information/images may address individual commodities meeting the user-selected customization criteria, collections meeting the user-selected customization criteria, or both. Information may include information about a commodity in an identified image, requested by the user (e.g., relating to a customization criteria), or both. For example, transmitted information may include commodity price, collection price, provider information (e.g., name, location, hours), delivery options (e.g., store pick up, postal services), incentives (e.g., two for one), bundles, menus, specifications, sizes, materials, and directions to name just a few examples. Images may include individual images of commodities that meet the user-selected customization criteria or combinations of images as a collection. The user may view the results from the customization service 128 on the electronic device 112 via the shopping application 120.

Referring to block 240, in an embodiment, the user of the electronic device 112 may opt to take one or more additional actions. The optimization module 130, and/or another module, can manage an additional action on behalf of the customization service 128. Optional additional actions include, without limitation, trying on a commodity, requesting a sample, booking an appointment, making a reservation, placing a commodity on hold, making a counteroffer, inquiry about a bundle, and combinations thereof. For example, the user may try on a commodity either virtually or physically. If trying on virtually, a try-on module (not shown) may enable the user to visualize the commodity in a virtual environment such as on a person (e.g., clothing) or in a space such as a room or a yard (e.g., furniture, landscaping features). Alternatively or additionally, the user may physically try on (e.g., clothing) or see the actual commodity or sample thereof (e.g., furniture or landscape feature in a showroom) before purchasing a commodity. In an embodiment, the user may ask the optimization module 130 to arrange for the commodity to be delivered to a particular location (e.g., a local brick-and-mortar store) if it is not already at a location that is convenient for the user. In an embodiment, the user may ask the optimization module 130 to place the commodity on hold (with or without a down payment) for a predetermined amount of time. In this way, the user may ensure that the provider does not sell or otherwise remove the commodity before he or she has a chance to get to the relevant location. In an embodiment, the user may optionally request for a sample of a commodity, or for more information about a commodity, to be provided. As an example, the user may ask the optimization module 130 to have a sample (e.g., fabric, carpet, or color swatch) or other information (e.g., brochure, specification) sent to the user's home or other location.

Furthermore, in an embodiment the user may use the electronic device 112 to optionally make a reservation or schedule an appointment. For example, if the commodity identified by the optimization module 130 is a service-based commodity, such as a restaurant or a salon, the user may use his or her electronic device 112 to make the reservation or appointment. For example, the user may use the electronic device 112 to call the service provider or to connect to the provider's website to make a reservation or appointment. Alternatively, the user may instruct the optimization module 130 to make an appointment or reservation. In an embodiment, if the optimization module 130 can access the user's calendar, the optimization module 130 may make a reservation/appointment during a time on the calendar that is open or free. The optimization module 130 (or another module/application program) may also enter the reservation/appointment (together with any other pertinent information) in the calendar.

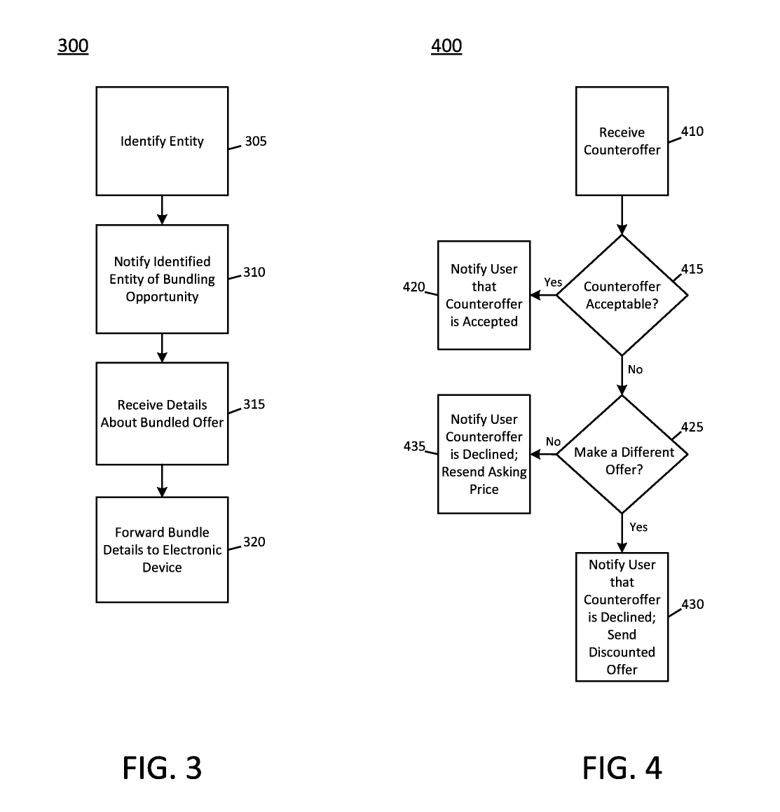

In an embodiment, the user may opt to inquire about the availability of a bundle of commodities, make a counteroffer to a given original purchase price, or both. FIGS. 3 and 4, below, illustrate an embodiment concerning bundling opportunities and counteroffers, respectively. Thus, these optional actions are discussed in connection with FIG. 3 and FIG. 4.

Referring to diamond 245, the purchasing module 132 may determine whether the user intends to purchase one or more commodities, collections of commodities, bundles of commodities, coupons, or vouchers, or if the user intends to pay a down payment, a discounted or otherwise reduced price, or any other transaction related to payment or purchase of a commodity. For example, the electronic device 112 may enable display of GUI on a touch screen display or the like. See, e.g., FIGS. 8, 9, and 10, below. The GUI may include one or more user-selectable options, fields to fill-in, or both to enable the user to communicate relevant purchasing (or other) information to the purchasing module 132.

Referring to block 250, having received the relevant purchasing information (and/or other information) from the electronic device 112, the purchasing module 132 may facilitate completing the transaction. For example, the purchasing module 132 may enable the user to use the electronic device 112 to check out as is known in the art. In an embodiment, checking out may include one or more of verifying payment information (e.g., credit/debit card, preregistered payment account), enabling user-selection of a delivery option (e.g., via a GUI on the electronic device 112) such as a delivery service or in-store pick up, and sending a confirmation to the electronic device 112 or other compute node associated with the user.

In an embodiment where the user has gone to a provider's 116a, 116b brick-and-mortar store, the user may or may not use the electronic device 112 to purchase a commodity. For example, if the commodity is a service, the user may obtain the service (e.g., dinner, hair appointment) before payment. Alternatively, if the commodity is a good, the user may try on the good (e.g., clothing) or actually see the good or a sample of a good (e.g., furniture, plant, fabric swatch) before making a purchase. In these examples, and other examples similar thereto, the user may use the electronic device 112 to pay for the service and/or good via the purchasing module 132 as is described above. In an embodiment, however, the user may directly pay the provider 116a, 116b for the good and/or service obtained.

Referring to diamond 255, if the user does not show an interest in a commodity (e.g., depicted in an image) returned by the customization service 128, the customization service 128 may determine if the user would like to try again. For example, the user may initiate another search such as by modifying or changing customization criteria. The customization service 128, however, may automatically provide the user with a “try again” option if it has not received user input within a predetermined amount of time. In an embodiment, a time out may occur during any period where the customization service 128 does not receive user input within a predetermined amount of time. Thus, the user may actively decline another try (e.g., selecting a “no” option on a GUI or the like) or passively decline another try by allowing a time out to occur.

In should be noted that an embodiment of process 200 may use more or less than all of the operations shown in FIG. 2, use a different sequence of operations, and/or use different combinations of options. As one non-limiting example, an embodiment of process 200 allows a user to purchase a commodity (e.g., a dinner coupon) before taking an optional action (e.g., making a reservation for dinner).

As is shown in FIG. 1, an embodiment of the customization service 128 may include the bundling module 134. Generally, the bundling module 134 facilitates bundling of one or more commodities. Bundles may be customized for the user based on user-selected customization criteria, information obtained by data mining, or both. An embodiment of a bundling process 300 may include the flow shown in FIG. 3, or a modification thereof.

Referring to block 305, the bundling module 134 may identify one or more entities to notify of a potential bundling opportunity. Identified entities may include one or more providers 116a, 116b, the multi-provider resource 118, or both. The bundling module 134 may identify one or more entities in response to a user request for bundling such as by a direct user request or inquiry, or by an indirect user request such as by showing interest in a collection or by the generation of a collection. The bundling module 134 may also identify an entity in response to identifying an image of a commodity from the provider storage 148. In an embodiment, the identified images may be associated with a tag or other indicator indicating that the subject commodity may be bundled or that the provider is amenable to bundling commodities. In an embodiment combinations of user requests and tags or other indicators, may cause the bundling module 134 to identify appropriate entities. And in an embodiment, one or more different events or combinations of events may cause the bundling module 134 to identify one or more appropriate entities.

In an embodiment, it may be sufficient for the bundling module 134 to identify only the multi-provider resource 118. For instance, the multi-provider resource 118 may provide a bundling service to the providers 116a, 116b, or it may be easier for the multi-provider resource 118 to identify particular providers 116a, 116b that may be interested in bundling opportunities. An embodiment, however, contemplates identifying providers 116a, 116b in addition to the multi-provider resource 118 or as an alternative to the multi-provider resource 118.

Referring to block 310, the bundling module 134 may send a notification to the identified entities. Generally, the notification lets the one or more identified entities know that there is an opportunity to create a bundle of commodities. The notification may also include other pertinent information such as the user-select criteria (e.g., type, preference, priority, collection) and/or other user selections, which commodity/commodities meet the user select-criteria, other commodities that are of interest to the given user, data mined using a data mining algorithm, and any other information that may be relevant to the provider 116a, 116b or the multi-provider resource 118 for providing a bundle of commodities. Generally, data mining may occur as is known in the art. The bundling module 134, providers 116a, 116b, and/or the multi-provider resource 118 may use information gleaned from such data mining to improve customization of bundles offered to the electronic device 112 user.

In response to receiving the notification from the bundling module 134, the providers 116a, 116b and/or the multi-provider resource 118 may create a bundle on the fly or may identify a previously created bundle that meets at least one of the user-selected customization criteria. The providers 116a, 116b, and/or multi-provider resource 118 may use information in the notification to create/identify a bundle that may be of interest to the user. For example, a given bundle may include one or more commodities in a collection created by the optimization module 130, one or more commodities identified from the provider storage 148, or other commodities that meet at least one of the user-selected customization criteria and/or that mined data indicates user interest. Providers 116a, 116b and the multi-provider resource 118 may each independently create/pre-create a bundle. Alternatively or additionally, one or more of provider 116a, provider 116b, and multi-provider resource 118 may cooperate to create/pre-create a bundle. Furthermore, bundles may be offered at a discounted price or with another incentive.

In block 315, the bundling module 134 may receive details about a created/identified bundle from the provider 116a, 116b and/or multi-provider resource 118. For example, the bundling module 134 may receive details about the contents of the bundle, the price of the bundle, any discounts or other incentives, price of each commodity in the bundle, pictures, specifications, and the like.

The bundling module 134 and/or optimization module 130 may respond to receiving bundle details by forwarding the bundle details to the electronic device 112. The bundling module 134/optimization module 130 may also forward other information such about individual commodities identified from the provider storage 148, collections generated by the optimization module 130, and any other information that may be of interest to the electronic device 112 user. In an embodiment, the process 300 may merge with or be parallel to the process 200 to enable the user to take one or more optional additional actions (e.g., FIG. 2, block 240), purchase (e.g., FIG. 2, diamond 245), try again (e.g., FIG. 2, diamond 255) and/or check out (e.g., FIG. 2, block 250).

As is shown in FIG. 1, an embodiment of the customization service 128 may include a negotiation module 136. Generally, the negotiation module 136 facilitates price negotiations. For instance, one of the optional additional actions a user may take in an embodiment of process 200 is to make a counteroffer to an original asking price of one or more individual commodities, collections of commodities, commodity bundles, or combinations of the forgoing. FIG. 4 includes a flow chart of an embodiment of a negotiation process 400. Embodiments of a negotiation process 400, however, may include fewer operations, additional operations, a different arrangement of operations, and combinations thereof.

In block 410, the negotiation module 136 receives the user's counteroffer via the electronic device 112. Referring to diamond 415, the negotiation module 136 may determine if the user's counteroffer is acceptable. In an embodiment, the negotiation module 136 may refer to negotiation parameters supplied the provider 116a, 116b or multi-provider resource 118 to determine if the user's counteroffer is acceptable. Provider-supplied negotiation parameters may be stored in a data store such as the storage 146, the reference storage 138, the provider storage 148, or any other storage that the customization service 128 may access, and combinations thereof. Access to such storage may include access over the network 110. In an embodiment, the negotiation module 136 may facilitate price negotiations between the user of electronic device 112 (e.g., via the shopping application 120) and the multi-provider resource 118 and/or the provider 116a, 116b. Thus, the negotiation module 136 may communicate the counteroffer to the provider 116a and/or 116b of the subject commodity, collection, and/or bundle, to the multi-provider resource 118, or both.

If the negotiation module 136 determines that the user's counteroffer is acceptable, or if the negotiation module 136 receives a notice of counteroffer acceptance from the provider 116a, 116b and/or the multi-provider resource 118, then, referring to block 420, the negotiation module 136 may notify the user that the counteroffer has been accepted. Thereafter, the user may take one or more other optional additional actions (e.g., FIG. 2, block 240, make a purchase (e.g., FIG. 2, diamond 245/block 250), or both.

If, however, the negotiation module 136 determines that the user's counteroffer is not acceptable, or receives a decline notification from the provider 116a, 116b, and/or multi-provider resource 118, then, in diamond 425 the negotiation module 136 may determine if a different offer is available. For example, the negotiation module 136 may consult negotiation parameters, the provider 116a and/or 116b, the multi-provider resource 118, or combinations thereof to determine if the original asking price may be discounted, but not by as much as the user's counteroffer. In an embodiment, the decisions of diamonds 415 and 425 may be made in a same inquiry.

In block 430, the negotiation module 136 may send a message (e.g., short messaging service, instant messaging, multimedia messaging service, email, voicemail, etc.) to the electronic device 112 informing the user that the counteroffer was declined and that a discounted price is being offered in its stead. If the user accepts the discounted offer, the user may take one or more other optional additional actions (e.g., FIG. 2, block 240), make a purchase (e.g., FIG. 2, diamond 245/block 250), or both. Although not shown, a time out may occur if the user does not respond to the discounted offer within a predetermined time. Furthermore, embodiments contemplate similar subsequent price negotiations.

In block 435, the negotiation module 136 may send a message to the electronic device 112 informing the user that the counteroffer was declined and that the user may still purchase the subject commodity, collection, or bundle at the original asking price. Again, if the user accepts the original asking price, the user may take one or more other optional additional actions (e.g., FIG. 2, block 240), make a purchase (e.g., FIG. 2, diamond 245/block 250), or both. If the user does not respond to the message within a given time, a time out may occur.

Embodiments thus allow an electronic device user to enjoy a customized shopping experience where purchasing options are presented to the user based on at least one of the user's indicated needs, such as a preference need.

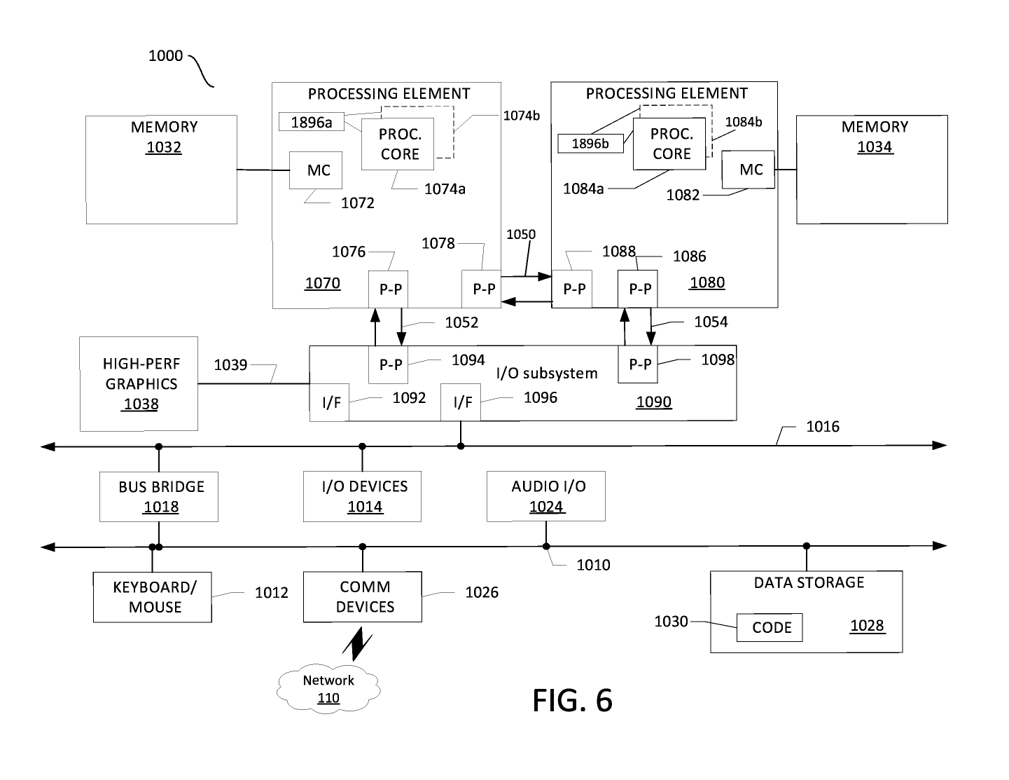

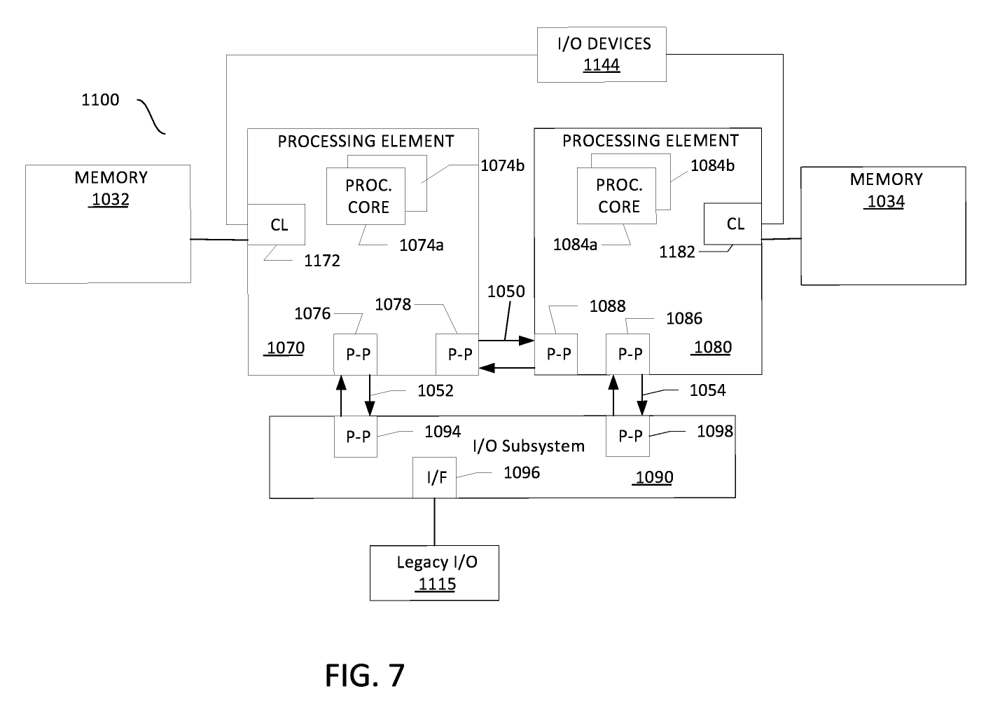

FIG. 5 illustrates a processor core 500 according to an embodiment. Processor core 500 may be the core for any type of processor, such as a micro-processor, an embedded processor, a digital signal processor (DSP), a network processor, or other device to execute code. Although only one processor core 500 is illustrated in FIG. 5, a processing element may alternatively include more than one of the processor core 500 illustrated in FIG. 5. (See, e.g., multi-core embodiments in FIGS. 6 and 7, below). Processor core 500 may be a single-threaded core or, for at least one embodiment, the processor core 500 may be multithreaded in that it may include more than one hardware thread context (or “logical processor”) per core.

FIG. 5 also illustrates a memory 570 coupled to the processor 500. The memory 570 may be any of a wide variety of memories (including various layers of memory hierarchy) as are known or otherwise available to those of skill in the art. The memory 570 may include one or more code instruction(s) 513 to be executed by the processor 500. The processor core 500 follows a program sequence of instructions indicated by the code 513. Each instruction enters a front end portion 510 and is processed by one or more decoders 520. The decoder may generate as its output a micro operation such as a fixed width micro operation in a predefined format, or may generate other instructions, microinstructions, or control signals, which reflect the original code instruction. The front end 510 also includes register renaming logic 525 and scheduling logic 530, which generally allocate resources and queue the operation corresponding to the convert instruction for execution.

The processor 500 is shown including execution logic 550 having a set of execution units 555-1 through 555-N. Some embodiments may include a number of execution units dedicated to specific functions or sets of functions. Other embodiments may include only one execution unit or one execution unit that can perform a particular function. The execution logic 550 performs the operations specified by code instructions.

After completion of execution of the operations specified by the code instructions, back end logic 560 retires the instructions of the code 513. In an embodiment, the processor core 500 allows out of order execution but requires in order retirement of instructions. Retirement logic 565 may take a variety of forms as known to those of skill in the art (e.g., re-order buffers or the like). In this manner, the processor core 500 is transformed during execution of the code 513, at least in terms of the output generated by the decoder, the hardware registers and tables utilized by the register renaming logic 525, and any registers (not shown) modified by the execution logic 550.

Although not illustrated in FIG. 5, a processing element may include other elements on chip with the processor core 500. For example, a processing element may include memory control logic (see, e.g., MC 1072 of FIG. 6, below) along with the processor core 500. The processing element may include I/O control logic and/or may include I/O control logic integrated with memory control logic (see, e.g., CL 1182 of FIG. 7, below). The processing element may also include one or more caches.

Referring now to FIG. 6, shown is a block diagram of a system embodiment 1000 in accordance with an embodiment of the present invention. Shown in FIG. 6 is a multiprocessor system 1000 that includes a first processing element 1070 and a second processing element 1080. While two processing elements 1070 and 1080 are shown, it is to be understood that an embodiment of system 1000 may also include only one such processing element.

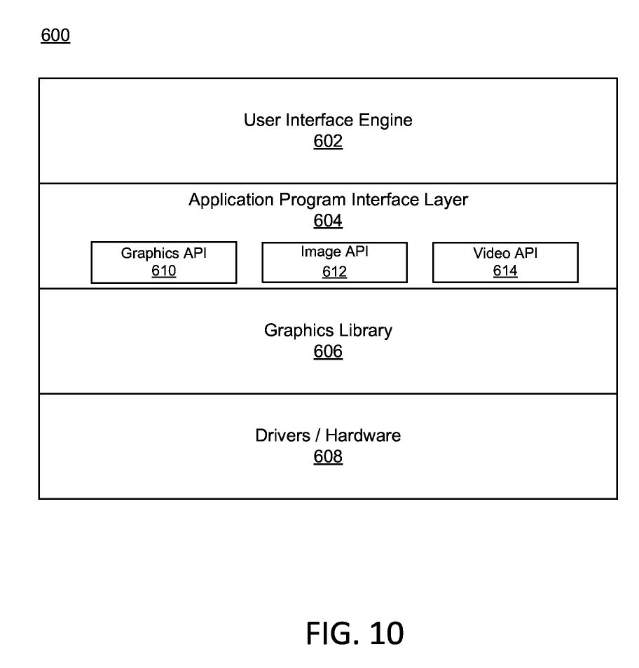

System 1000 is illustrated as a point-to-point interconnect system, wherein the first processing element 1070 and second processing element 1080 are coupled via a point-to-point interconnect 1050. It should be understood that any or all of the interconnects illustrated in FIG. 10 may be implemented as multi-drop bus rather than point-to-point interconnect.

As shown in FIG. 6, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 5.

Each processing element 1070, 1080 may include at least one shared cache 1896. The shared cache 1896a, 1896b may store data (e.g., instructions) that are utilized by one or more components of the processor, such as the cores 1074a, 1074b and 1084a, 1084b, respectively. For example, the shared cache may locally cache data stored in a memory 1032, 1034 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the present invention is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, microarchitectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

First processing element 1070 may further include memory controller logic (MC) 1072 and point-to-point (P-P) interfaces 1076 and 1078. Similarly, second processing element 1080 may include a MC 1082 and P-P interfaces 1086 and 1088. As shown in FIG. 6, MC's 1072 and 1082 couple the processors to respective memories, namely a memory 1032 and a memory 1034, which may be portions of main memory locally attached to the respective processors. While MC logic 1072 and 1082 is illustrated as integrated into the processing elements 1070, 1080, for alternative embodiments the MC logic may be discrete logic outside the processing elements 1070, 1080 rather than integrated therein.

First processing element 1070 and second processing element 1080 may be coupled to an I/O subsystem 1090 via P-P interconnects 1052 and 1054, respectively. As shown in FIG. 6, I/O subsystem 1090 includes P-P interfaces 1094 and 1098. Furthermore, I/O subsystem 1090 includes an interface 1092 to couple I/O subsystem 1090 with a high performance graphics engine 1038, a point-to-point interconnect 1039 may couple these components.

In turn, I/O subsystem 1090 may be coupled to a first bus 1016 via an interface 1096. In one embodiment, first bus 1016 may be a Peripheral Component Interconnect (PCI) bus, or a bus such as a PCI Express bus or another third generation I/O interconnect bus, although the scope of the present invention is not so limited.

As shown in FIG. 6, various I/O devices 1014 may be coupled to first bus 1016, along with a bus bridge 1018, which may couple first bus 1016 to a second bus 1010. In one embodiment, second bus 1010 may be a low pin count (LPC) bus. Various devices may be coupled to second bus 1010 including, for example, a keyboard/mouse 1012, communication device(s) 1026 (which may in turn be in communication with the network 110), and a data storage unit 1028 such as a disk drive or other mass storage device which may include code 1030, in one embodiment. The code 1030 may include instructions for performing an embodiment described herein. Further, an audio I/O 1024 may be coupled to second bus 1010.

Note that other embodiments are contemplated. For example, instead of the point-to-point architecture of FIG. 6, a system may implement a multi-drop bus or another such communication topology. Also, the elements of FIG. 6 may alternatively be partitioned using more or fewer integrated chips than shown in FIG. 6.

Referring now to FIG. 7, shown is a block diagram of a third system embodiment 1100 in accordance with an embodiment of the present invention. Like elements in FIGS. 6 and 7 bear like reference numerals, and certain aspects of FIG. 6 have been omitted from FIG. 7 in order to avoid obscuring other aspects of FIG. 7.

FIG. 7 illustrates that the processing elements 1070, 1080 may include integrated memory and I/O control logic (“CL”) 1172 and 1182, respectively. For at least one embodiment, the CL 1172, 1182 may include memory control logic (MC) such as that described above in connection with FIG. 6. In addition, CL 1172, 1182 may also include I/O control logic. FIG. 7 illustrates that not only are the memories 1032, 1034 coupled to the CL 1172, 1182, but also that I/O devices 1114 may also be coupled to the control logic 1172, 1182. Legacy I/O devices 1115 may be coupled to the I/O subsystem 1090.

The computer systems depicted in FIGS. 6 and 7 are schematic illustrations of embodiments of computing systems, which may be utilized to implement various embodiments discussed herein. It will be appreciated that various components of the systems depicted in FIGS. 6 and 7 may be combined in a system-on-a-chip (SoC) architecture.

The diagram of FIG. 8 illustrates functional components of an embodiment of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

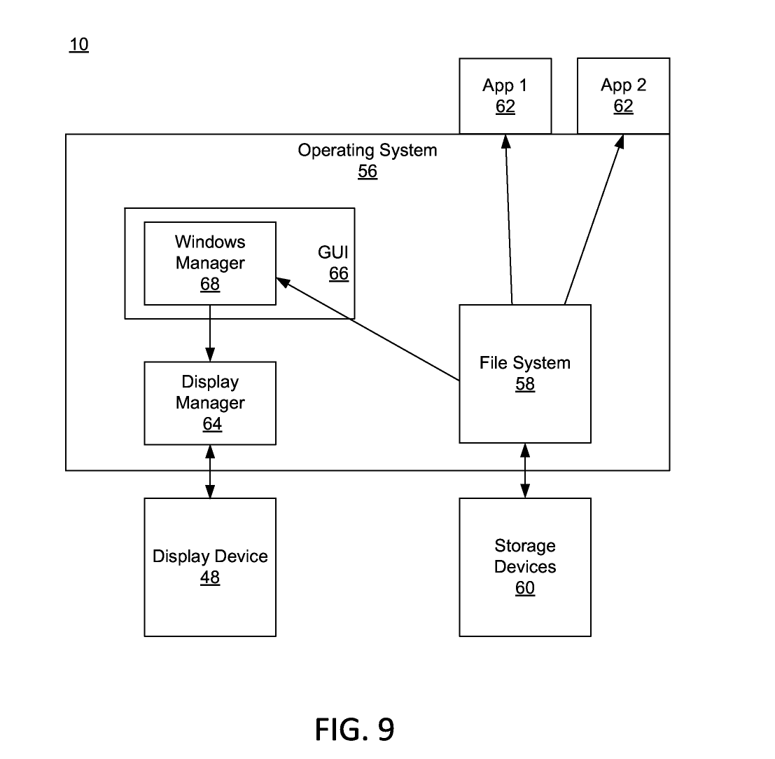

FIG. 9 is a schematic block diagram 10 showing how information can be displayed to a user of a compute node in an embodiment of the invention. For example, an operating system 56 can include a display manager 64, which may control information that is presented to a display device 48 (e.g., without limitation, a touch screen) for display to the user. A graphical user interface 66 is another component of the operating system 56 that interacts with the display manager 64 to present information on the display device 48. For example, the graphical user interface 66 can provide the display manager 64 with data that describes the appearance and position of windows, icons, control elements, and similar types of user interface objects. The graphical user interface 66 might provide this information directly to the display manager 64, or via a windows manager 68. The windows manager 68 can control the display of windows in which data is presented to the user. Such data may be documents generated by application programs 62, or the contents of a file system 58, storage device 60, or both.

FIG. 10 is a block diagram of an example system layer structure 600 that can be utilized to implement an embodiment described herein. Other system layer implementations, however, can also be used. In some implementations, a user interface engine, such as the UI engine 602, or another UI engine capable of generating a three-dimensional user interface environment, operates at an application level 602 and implements graphical functions and features available through an application program interface (API) layer 604. Example graphical functions and features include graphical processing, supported by a graphics API 610, image processing, support by an imaging API 612, and video processing, supported by a video API 614. The API layer 604, in turn, interfaces with a graphics library layer 606. The graphics library layer 604 can be implemented, for example, as a software interface to graphics hardware, such as an implementation of the OpenGL specification. A driver/hardware layer 608 includes drivers and associated graphics hardware, such as a graphics card and associated drivers.

An embodiment may be implemented in program code, or instructions, which may be stored in, for example, volatile and/or non-volatile memory, such as storage devices and/or an associated machine readable or machine accessible medium including, but not limited to floppy disks, optical storage, solid-state memory, hard-drives, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a medium through which the program code may pass, such as antennas, optical fibers, communications interfaces, etc. Program code may be transmitted in the form of packets, serial data, parallel data, etc., and may be used in a compressed or encrypted format.

An embodiment of the invention may be described herein with reference to data such as instructions, functions, procedures, data structures, application programs, configuration settings, code, and the like. When the data is accessed by a machine, the machine may respond by performing tasks, defining abstract data types, establishing low-level hardware contexts, and/or performing other operations, as described in greater detail herein. The data may be stored in volatile and/or non-volatile data storage. The terms “code” or “program” cover a broad range of components and constructs, including applications, drivers, processes, routines, methods, modules, and subprograms and may refer to any collection of instructions which, when executed by a processing system, performs a desired operation or operations. Additionally, an embodiment may include processes that use greater than or fewer than all of the disclosed operations, use the same operations in a different sequence, or use combinations, subdivisions, or other alterations of individual operations disclosed herein.

In an embodiment, use of the term control logic includes hardware, such as transistors, registers, or other hardware, such as programmable logic device; control logic may also include software or code, which may be integrated with hardware, such as firmware or micro-code. A processor or controller may include control logic intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like.

The following examples pertain to further embodiments. Specifics in the examples may be used anywhere in one or more embodiments.

Example 1 may include subject matter such as, a system, a method, a computer program, or an apparatus such as a network-accessible compute node for customized shopping which includes a local storage storing reference images, each reference image depicting at least one preference in a plurality of preferences, each preference in the plurality of preferences associated with a distinctive pattern and a preference criterion, and an optimization module to learn the distinctive patterns from the reference images, access a remote storage storing images of commodities, and use pattern recognition to identify, from the remote storage, one or more images of commodities meeting the preference criterion selected by a user.

In Example 2, the subject matter of Example 1 may optionally include wherein, the optimization module is to identify a type of commodity associated with a user-selected commodity-type criterion and the preference associated with the user-selected preference criterion, the commodity-type criterion selectable from the group consisting of clothing, furniture, home décor, yard décor, buildings, electronics, plants, water features, landscaping, nail salon, nail technician, hair salon, hair stylist, tanning salon, bridal salon, lawn care services, real estate, restaurants, fitness, and interior decorators, and the preference criterion selectable from the group consisting of color, pattern, material, size, purpose, types of exercise, martial arts, taekwondo, judo, karate, personal trainers, weight lifting, boot camp, cross training, yoga, Ashtanga, Vinyasa, Bikram, Pilates, boxing, modern, eclectic, ethnic, traditional, country, western, cottage, Victorian, Elizabethan, era-related, plantation, ranch, beach, gothic, nouveau, celebrity emulation, architectural, brick, wood, stucco, columns, porch, number of rooms, types of rooms, square feet, genre-based, rock, family, adventure, age-based, child, adult, tween, teen, senior, restaurant types, fast food, family style, pizzeria, burgers, pub, fine dining, types of cuisine, French, Italian, Chinese, Thai, South American, Mexican, burgers, vegetarian, barbeque, types of salon services, cuts, permanent, straitening, blow-dry, highlights, types of electronics, smartphones, ultrabooks, laptops, desktops, printers, routers, e-readers, mobile phones, servers, specifications, amount of memory, number and type of processors, display size, shape, vintage, processor types, curly, straight, mountain, 3-dimensional, casual, tropical, trendy, sporty, tropical, desert, forest, native, pools, arbors, beds, gardens, walkways, fire pits, related to a particular country, and the like.

In Example 3, the subject matter of Examples 1, 2, or both may optionally include wherein the optimization module is to identify one or more user-selected customization criteria selected from the group consisting of the preference criterion, the commodity-type criterion, a price criterion, a color criterion, a size criterion, a price limit, a best price, a preferred provider, a number of results to return, a portion criterion, an award criterion, a demerit criterion, a wait-time criterion, a provided image criterion, and a priority criterion, which indicates that a designated user-selected customization criteria is to be given more weight than other user-selected customization criteria, and to prioritize the identified one or more images of commodities based on the user-selected priority criteria.

In Example 4, the subject matter of Examples 1, 2, and/or 3, may optionally include wherein the optimization module is to send information, one or more images of commodities, or both, to an electronic device associated with the user, information selected from one or more of, information relating to the identified one or more images, details about a bundled offer, an acceptance of a counteroffer, a denial of a counter offer, a discounted offer, commodity pricing, a commodity provider, a commodity specification, an incentive, delivery options, menus, sizes, materials, directions, and the contents of a collection, and one or more images selected from, individual images of commodities, a collection of images from the remote storage, a collection of images including a user-provided image, and images of commodities in a bundle of commodities.

In Example 5, the subject matter of any of the above examples may optionally include, a purchasing module to enable purchase of, partial payment for, or both, one or more selected from the group consisting of: a commodity shown in the identified one or more images, a collection of commodities, a bundle of commodities, a coupon for a commodity shown in the identified one or more images, and a voucher for a commodity shown in the identified one or more images, the purchase, partial payment, or both to be made over a network.

In Example 6, the subject matter of any of the above examples, alone or in combination, may optionally include, wherein the optimization module is to create a collection of at least two commodities, one of the at least two commodities in the collection shown in the identified one or more images of commodities, the other of the at least two commodities in the collection either depicted in an image provided by the user or shown in the identified one or more images of commodities, the other of the at least two commodities optionally meeting the user-selected preference criteria.

In Example 7, the subject matter of Examples 1, 2, 3, 4, or 5 may optionally include, wherein the optimization module is to manage one or more actions relating to a commodity shown in the identified one or more images, the managed one or more actions selected from the group consisting of, placing a particular commodity on hold, scheduling an appointment, adding the scheduled appointment to a calendar, making a reservation, adding the made reservation to the calendar, requesting a sample of a particular commodity, placing a particular commodity on layaway, trying on a particular commodity, making a counteroffer to an originally offered price, and bundling of commodities.

In Example 8, the subject matter of Example 7 may optionally include a bundling module to identify an entity, and to notify the identified entity of an opportunity to create a customized bundle, to identify a pre-created bundle, or both, the notification to include information selected from one or more of, a commodity offered by the identified entity that meets the user-selected preference criterion, one or more user-selected commodity type-criteria, and information obtained by data mining techniques.

In Example 9, the subject matter of Example 8 may optionally include wherein the identified entity includes a given commodity provider, a resource for a group of commodity providers, or both, the bundling module to identify the entity in response to one or more of, a user-selected customization criterion, an indicator associated with the identified one or more images of, and entity-expressed interest in bundling opportunities.

In Example 10, the subject matter of Example 7 may optionally include a negotiation module to receive a counteroffer to an originally offered price, determine if the counteroffer is an acceptable counteroffer, and if not, determine if a the originally offered price can be discounted to a price that is greater than the counteroffer.

Example 11 may include subject matter such as, a system, a method, a computer program, or an apparatus for customized shopping, which includes learning to recognize a pattern from one or more reference images, the pattern associated with a user-selected preference criteria, accessing a remote storage storing a plurality of images of commodities, and in response to recognizing the pattern in one or more images of commodities of the plurality of images of commodities, identify the one or more images of commodities as meeting the user-selected preference criteria.

Example 12 can include the subject matter of Example 11 and also include, identifying a good or a service associated with a user-selected commodity-type criteria and a preference associated with the user-selected preference criteria, the commodity-type criteria to be selected from at least one of, clothing, a type of garment, furniture, a type of furniture, home décor, yard décor, a building, a type of building, a single-family home, electronics, a type of electronics, a plant, a type of plant, a water feature, landscaping services, a nail salon, a nail technician, a hair salon, a hair stylist, a tanning salon, a bridal salon, lawn care services, real estate, a real estate agent, a restaurant, a fitness facility, a fitness professional, and interior decorators, and the preference criteria selected from at least one of, a universal user-defined preference, a commodity-specific user-defined preference, a color, a pattern, a material, a size, a purpose, a type of exercise, modern, eclectic, ethnic, traditional, country, western, cottage, Victorian, Elizabethan, a particular era, plantation, ranch, beach, gothic, nouveau, a celebrity to emulate, a type of architectural style, brick, wood, stucco, columns, porch, a number of rooms, a type of room, square feet, a type of genre, rock, family, adventure, an age, child, adult, tween, teen, senior, a type of restaurant, fast food, family style, pizzeria, burgers, pub, fine dining, a type of cuisine, a type of salon services, a type of hair cut, a permanent, straitening, a blow-dry, highlights, a type of electronics, a smartphone, an ultrabook, a laptop, a desktop, a printer, a router, a specification, vintage, a type of processor type, curly, straight, mountain, 3-dimensional, casual, tropical, trendy, sporty, a country, a land mass, and a geographical region.

Example 13 can include the subject matter of Example 11 or 12 and can also include, in response to the identification of the preference associated with the user-selected preference criteria, refer to the one or more reference images to learn, update learning, or remember the pattern associated with the user-selected preference criteria and the identified preference.

Example 14 can include the subject matter of Example 13 and can also include, learning to recognize plural patterns from plural reference images using a pattern recognition algorithm, the machine to learn the plural patterns during periods of low machine usage

Example 15 can include the subject matter of Example 14 and also include, learning to recognize the pattern from the one or more reference images, which depict a user-designated personal preference

Example 16 can include the subject matter of any of Examples 11-16 and can also include, processing a transaction relating to one or more of, a purchase of a particular commodity, a purchase of a coupon for a particular commodity, a purchase of a voucher for a particular commodity, a partial payment for a particular commodity, a purchase of a bundle of commodities, a purchase of a collection of commodities, and a purchase of one or more commodities at a discounted price.

Example 17 can include the subject matter of Example 11, 12, 13, 14, or 15, and can also include, in response to a user-selected collection criteria create a collection of at least two commodities, one of the at least two commodities in the collection depicted in the one or more images identified from the plurality of images, the other of the at least two commodities in the collection depicted in the one or more images identified from the plurality of images or depicted in an image supplied by the user.

Example 18 can include the subject matter of Examples 11, 16, or 17 and can also include, taking one or more actions selected from the group consisting of, place a particular commodity on hold, schedule an appointment, add a scheduled appointment to a calendar, make a reservation, add a confirmed reservation to a calendar, request a sample, place a particular commodity on layaway, and enable the user to virtually or physically try on a commodity.

Example 19 can include the subject matter of Example 11, or 16, 17, or 18 and can also include, determining whether a commodity depicted in the identified one or more images is a candidate for bundling, in response to determining that the commodity is a candidate for bundling, notify a provider, a multi-provider resource, or both, of the opportunity to create or identify a bundle of commodities including the candidate commodity, and in response to receiving information about a created or identified bundle of commodities from the provider, the multi-provider resource, or both, communicate the information about the created or identified bundle to an electronic device associated with the user

Example 20 can include the subject matter of Examples 11, 17, 18, or 19 and can also include, sending information about a particular commodity depicted in the identified one or more images to an electronic device associated with the user, the information to include an original purchase price for the particular commodity, in response to receiving a counteroffer to the original purchase price, determine whether the counteroffer is acceptable, in response to a determination that the counteroffer is not acceptable, determine whether the original purchase price can be discounted to a price between the original purchase price and the counteroffer, and in response to a determination that the original purchase price can be discounted send the discounted price to the electronic device, otherwise resend the original purchase price.

Example 21 may include subject matter such as, a system, a method, a computer program, or an apparatus to enable customized shopping, which may include identifying a user-selected customization criteria selected from one or more of a commodity-type criterion, a preference criterion, a collection criterion, a bundle criterion, and a priority of criteria criterion; communicate the user-selected customization criteria to a cloud-based customized shopping service, and from the customized shopping service, receive an image of a commodity identified as meeting at least one user-selected customization criteria based on a pattern recognition technique. Can also include at least one processor, and control logic coupled to the at least one processor.

Example 22 can include the subject matter of Example 21 and also can include, storing at least one image designated by the user as showing the user's personal preference, the at least one image to enable a pattern recognition algorithm to learn the user's personal preference. Example 22 can include a storage to store the at least one image.

Example 23 can include the subject matter of Examples 21 and 22 and can include storing at least one image of a commodity to be included in a collection of commodities created by the cloud-based customized shopping service and including the commodity depicted in the received image. In Example 23, the storage can also store the at least one image of a commodity to be included in a collection of commodities.

Example 24 can include the subject matter of any of Examples 21-23 and can include, entering into a calendar application program, an appointment or reservation relating to the commodity shown in the received image.

Example 25 can include the subject matter of any of Examples 21-24 and can include enabling a virtual try-on the commodity shown in the received image.

Example 26 can include the subject matter of any of Examples 21-25 and can include receiving an original purchase price for the commodity shown in the received image, and enable negotiations for a purchase price that is less than the original purchase price.

Example 27, may include subject matter such as, a system, a method, a computer program, or an apparatus to enable customized shopping, which may include a storage device storing plural sets of images, each set of images in the plural sets of images corresponding to a given commodity, and each image in a given set of images to show a different feature of the given commodity, the different features of the commodity capable of being distinguished by a pattern recognition algorithm, and at least one processor and control logic coupled to the storage device, the at least one processor to, receive the plural sets of images from one or more commodity providers, store the received plural sets of images on the storage device, and enable communications with a remote customization service.

Example 28 can include the subject matter of Example 27 and can optionally, determine if a bundle of commodities can be created or identified based on one or more of, a commodity identified from the storage as meeting a particular user-selected preference criteria, data collected using a data mining algorithm, and at least two user-selected customization criteria.

Example 29 can include the subject matter of Examples 27 and 28, and can optionally, receive a notification from the remote customization service, the notification to include the at least two user-selected customization criteria selected from, a commodity-type criteria, a preference criteria, a priority of customization criteria, a collection criteria, a bundle-inquiry criteria, and a user-requested price.

Example 30 can include the subject matter of Examples 27, 28, 29, or combinations thereof, and can optionally, determine if the user-requested price is an acceptable price, and in response to a determination that the user-requested price is not an acceptable price, determine whether to offer a discounted price that is greater that the user-requested price and less than an originally offered price.

The following clauses and/or examples pertain to further embodiments:

One example embodiment may be a network-accessible compute node comprising a local storage storing reference images, each reference image depicting at least one preference in a plurality of preferences, each preference in the plurality of preferences associated with a distinctive pattern and a preference criterion and an optimization module to, learn the distinctive patterns from the reference images, access a remote storage storing images of commodities, and use pattern recognition to identify, from the remote storage, one or more images of commodities meeting the preference criterion selected by a user, said optimization module to receive a user selection of a collection comprising two or more commodities, together with one or more preferences, said optimization module to locate the collection at a single provider that can provide the two or more commodities having the specified preferences. The network-accessible compute node may also include wherein the optimization module is to identify a type of commodity associated with a user-selected commodity-type criterion and the preference associated with the user-selected preference criterion, the commodity-type criterion selectable from the group consisting of clothing, furniture, home décor, yard décor, buildings, electronics, plants, water features, landscaping, nail salon, nail technician, hair salon, hair stylist, tanning salon, bridal salon, lawn care services, real estate, restaurants, fitness, and interior decorators, and the preference criterion selectable from the group consisting of: a universal user-defined preference, a commodity-specific user-defined preference, color, pattern, material, size, purpose, types of exercise, modern, eclectic, ethnic, traditional, country, western, cottage, Victorian, Elizabethan, era-related, plantation, ranch, beach, gothic, nouveau, celebrity emulation, architectural, brick, wood, stucco, columns, porch, number of rooms, types of rooms, square feet, genre-based, rock, family, adventure, age-based, child, adult, tween, teen, senior, restaurant types, fast food, family style, pizzeria, burgers, pub, fine dining, types of cuisine, types of salon services, cuts, permanent, straitening, blow-dry, highlights, types of electronics, smartphones, ultrabooks, laptops, desktops, printers, routers, specifications, vintage, processor types, curly, straight, mountain, 3-dimensional, casual, tropical trendy, sporty, and related to a particular country. The network-accessible compute node may include wherein the optimization module is to identify one or more user-selected customization criteria selected from the group consisting of the preference criterion, the commodity-type criterion, a price criterion, a color criterion, a size criterion, a price limit, a best price, a preferred provider, a number of results to return, a portion criterion, an award criterion, a demerit criterion, a wait-time criterion, a provided image criterion, and a priority criterion, which indicates that a designated user-selected customization criteria is to be given more weight than other user-selected customization criteria, and to prioritize the identified one or more images of commodities based on the user-selected priority criteria. The network-accessible compute node may include wherein the optimization module is to send information, one or more images of commodities, or both, to an electronic device associated with the user, information selected from one or more of information relating to the identified one or more images, details about a bundled offer, an acceptance of a counteroffer, a denial of a counter offer, a discounted offer, commodity pricing, a commodity provider, a commodity specification, an incentive, delivery options, menus, sizes, materials, directions, and the contents of a collection, and one or more images selected from individual images of commodities, a collection of images from the remote storage, a collection of images including a user-provided image, and images of commodities in a bundle of commodities. The network-accessible compute node may include further comprising, a purchasing module to enable purchase of, partial payment for, or both, one or more selected from the group consisting of: a commodity shown in the identified one or more images, a collection of commodities, a bundle of commodities, a coupon for a commodity shown in the identified one or more images, and a voucher for a commodity shown in the identified one or more images, the purchase, partial payment, or both to be made over a network. The network-accessible compute node may include wherein the optimization module is to create a collection of at least two commodities, one of the at least two commodities in the collection shown in the identified one or more images of commodities, the other of the at least two commodities in the collection either depicted in an image provided by the user or shown in the identified one or more images of commodities, the other of the at least two commodities meeting the user-selected preference criteria. The network-accessible compute node may include wherein the optimization module is to manage one or more actions relating to a commodity shown in the identified one or more images, the managed one or more actions selected from the group consisting of: placing a particular commodity on hold, scheduling an appointment, adding the scheduled appointment to a calendar, making a reservation, adding the made reservation to the calendar, requesting a sample of a particular commodity, placing a particular commodity on layaway, trying on a particular commodity, making a counteroffer to an originally offered price, and bundling of commodities. The network-accessible compute node may include further comprising a bundling module to identify an entity, and to notify the identified entity of an opportunity to create a customized bundle, to identify a pre-created bundle, or both, the notification to include information selected from one or more of: a commodity offered by the identified entity that meets the user-selected preference criterion, one or more user-selected commodity type-criteria, and information obtained by data mining techniques. The network-accessible compute node may include wherein the identified entity includes a given commodity provider, a resource for a group of commodity providers, or both, the bundling module to identify the entity in response to one or more of a user-selected customization criterion, an indicator associated with the identified one or more images of, and entity-expressed interest in bundling opportunities. The network-accessible compute node may include further comprising a negotiation module to receive a counteroffer to an originally offered price, determine if the counteroffer is an acceptable counteroffer, and if not, determine if a the originally offered price can be discounted to a price that is greater than the counteroffer.

In another example embodiment may include at least one non-transitory machine accessible storage medium having instructions stored thereon, the instructions, when executed on a machine, cause the machine to learn to recognize a pattern from one or more reference images, the pattern associated with a user-selected preference criteria, access a remote storage storing a plurality of images of commodities, in response to recognizing the pattern in one or more images of commodities of the plurality of images of commodities, identify the one or more images of commodities as meeting the user-selected preference criteria, receive a user selection of a collection comprising two or more commodities, together with one or more preferences, and locate the collection at a single provider that can provide the two or more commodities having the specified preferences. The at least one machine accessible storage medium may include further comprising instructions that cause the machine to, identify a good or a service associated with a user-selected commodity-type criteria and a preference associated with the user-selected preference criteria, the commodity-type criteria to be selected from at least one of, clothing, a type of garment, furniture, a type of furniture, home décor, yard décor, a building, a type of building, a single-family home, electronics, a type of electronics, a plant, a type of plant, a water feature, landscaping services, a nail salon, a nail technician, a hair salon, a hair stylist, a tanning salon, a bridal salon, lawn care services, real estate, a real estate agent, a restaurant, a fitness facility, a fitness professional, and interior decorators, and the preference criteria selected from at least one of, a universal user-defined preference, a commodity-specific user-defined preference, a color, a pattern, a material, a size, a purpose, a type of exercise, modern, eclectic, ethnic, traditional, country, western, cottage, Victorian, Elizabethan, a particular era, plantation, ranch, beach, gothic, nouveau, a celebrity to emulate, a type of architectural style, brick, wood, stucco, columns, porch, a number of rooms, a type of room, square feet, a type of genre, rock, family, adventure, an age, child, adult, tween, teen, senior, a type of restaurant, fast food, family style, pizzeria, burgers, pub, fine dining, a type of cuisine, a type of salon services, a type of hair cut, a permanent, straitening, a blow-dry, highlights, a type of electronics, a smartphone, an ultrabook, a laptop, a desktop, a printer, a router, a specification, vintage, a type of processor type, curly, straight, mountain, 3-dimensional, casual, tropical, trendy, sporty, a country, a land mass, and a geographical region. The at least one machine accessible storage medium may include further comprising instructions that cause the machine to, in response to the identification of the preference associated with the user-selected preference criteria, refer to the one or more reference images to learn, update learning, or remember the pattern associated with the user-selected preference criteria and the identified preference. The at least one machine accessible storage medium may include further comprising instructions that cause the machine to, learn to recognize plural patterns from plural reference images using a pattern recognition algorithm, the machine to learn to recognize the plural patterns during periods of low machine usage. The at least one machine accessible storage medium may include further comprising instructions that cause the machine to learn to recognize the pattern from the one or more reference images, which depict a user-designated personal preference. The at least one machine accessible storage medium may include further comprising instructions that cause the machine to process a transaction relating to one or more of a purchase of a particular commodity, a purchase of a coupon for a particular commodity, a purchase of a voucher for a particular commodity, a partial payment for a particular commodity, a purchase of a bundle of commodities, a purchase of a collection of commodities, and a purchase of one or more commodities at a discounted price. The at least one machine accessible storage medium may include further comprising instructions that cause the machine to, in response to a user-selected collection criteria create a collection of at least two commodities, one of the at least two commodities in the collection depicted in the one or more images identified from the plurality of images, the other of the at least two commodities in the collection depicted in the one or more images identified from the plurality of images or depicted in an image supplied by the user. The at least one machine accessible storage medium may include further comprising instructions that cause the machine to take one or more actions selected from the group consisting of place a particular commodity on hold, schedule an appointment, add a scheduled appointment to a calendar, make a reservation, add a confirmed reservation to a calendar, request a sample, place a particular commodity on layaway, and enable the user to virtually or physically try on a commodity. The at least one machine accessible storage medium may include further comprising instructions that cause the machine to determine whether a commodity depicted in the identified one or more images is a candidate for bundling, in response to determining that the commodity is a candidate for bundling, notify a provider, a multi-provider resource, or both, of the opportunity to create or identify a bundle of commodities including the candidate commodity, and in response to receiving information about a created or identified bundle of commodities from the provider, the multi-provider resource, or both, communicate the information about the created or identified bundle to an electronic device associated with the user. The at least one machine accessible storage medium may include send information about a particular commodity depicted in the identified one or more images to an electronic device associated with the user, the information to include an original purchase price for the particular commodity, in response to receiving a counteroffer to the original purchase price, determine whether the counteroffer is acceptable, in response to a determination that the counteroffer is not acceptable, determine whether the original purchase price can be discounted to a price between the original purchase price and the counteroffer, and in response to a determination that the original purchase price can be discounted send the discounted price to the electronic device, otherwise resend the original purchase price.

All optional features of apparatus(s) described above may also be implemented with respect to method(s) or process(es) described herein.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A network-accessible compute node comprising:
a local storage storing reference images, each reference image depicting at least one preference in a plurality of preferences, each preference in the plurality of preferences associated with a distinctive pattern and a preference criterion; and
an optimization module to, learn the distinctive patterns from the reference images, access a remote storage storing images of commodities, and use pattern recognition to identify, from the remote storage, one or more images of commodities meeting the preference criterion selected by a user, said optimization module to receive a user selection of a collection comprising two or more commodities, together with one or more preferences, said optimization module to locate the collection at a single provider that can provide the two or more commodities having the specified preferences.

2. The network-accessible compute node of claim 1 wherein, the optimization module is to identify a type of commodity associated with a user-selected commodity-type criterion and the preference associated with the user-selected preference criterion, the commodity-type criterion selectable from the group consisting of clothing, furniture, home décor, yard décor, buildings, electronics, plants, water features, landscaping, nail salon, nail technician, hair salon, hair stylist, tanning salon, bridal salon, lawn care services, real estate, restaurants, fitness, and interior decorators, and the preference criterion selectable from the group consisting of: a universal user-defined preference, a commodity-specific user-defined preference, color, pattern, material, size, purpose, types of exercise, modern, eclectic, ethnic, traditional, country, western, cottage, Victorian, Elizabethan, era-related, plantation, ranch, beach, gothic, nouveau, celebrity emulation, architectural, brick, wood, stucco, columns, porch, number of rooms, types of rooms, square feet, genre-based, rock, family, adventure, age-based, child, adult, tween, teen, senior, restaurant types, fast food, family style, pizzeria, burgers, pub, fine dining, types of cuisine, types of salon services, cuts, permanent, straitening, blow-dry, highlights, types of electronics, smartphones, ultrabooks, laptops, desktops, printers, routers, specifications, vintage, processor types, curly, straight, mountain, 3-dimensional, casual, tropical trendy, sporty, and related to a particular country.

3. The network-accessible compute node of claim 2 wherein the optimization module is to identify one or more user-selected customization criteria selected from the group consisting of the preference criterion, the commodity-type criterion, a price criterion, a color criterion, a size criterion, a price limit, a best price, a preferred provider, a number of results to return, a portion criterion, an award criterion, a demerit criterion, a wait-time criterion, a provided image criterion, and a priority criterion, which indicates that a designated user-selected customization criteria is to be given more weight than other user-selected customization criteria, and to prioritize the identified one or more images of commodities based on the user-selected priority criteria.

4. The network-accessible compute node of claim 1 wherein the optimization module is to send information, one or more images of commodities, or both, to an electronic device associated with the user, information selected from one or more of information relating to the identified one or more images, details about a bundled offer, an acceptance of a counteroffer, a denial of a counter offer, a discounted offer, commodity pricing, a commodity provider, a commodity specification, an incentive, delivery options, menus, sizes, materials, directions, and the contents of a collection, and one or more images selected from individual images of commodities, a collection of images from the remote storage, a collection of images including a user-provided image, and images of commodities in a bundle of commodities.

5. The network-accessible compute node of claim 1 further comprising, a purchasing module to enable purchase of, partial payment for, or both, one or more selected from the group consisting of: a commodity shown in the identified one or more images, a collection of commodities, a bundle of commodities, a coupon for a commodity shown in the identified one or more images, and a voucher for a commodity shown in the identified one or more images, the purchase, partial payment, or both to be made over a network.

6. The network-accessible compute node of claim 1 wherein the optimization module is to create a collection of at least two commodities, one of the at least two commodities in the collection shown in the identified one or more images of commodities, the other of the at least two commodities in the collection either depicted in an image provided by the user or shown in the identified one or more images of commodities, the other of the at least two commodities meeting the user-selected preference criteria.

7. The network-accessible compute node of claim 1 wherein the optimization module is to manage one or more actions relating to a commodity shown in the identified one or more images, the managed one or more actions selected from the group consisting of: placing a particular commodity on hold, scheduling an appointment, adding the scheduled appointment to a calendar, making a reservation, adding the made reservation to the calendar, requesting a sample of a particular commodity, placing a particular commodity on layaway, trying on a particular commodity, making a counteroffer to an originally offered price, and bundling of commodities.

8. The network-accessible compute node of claim 7, further comprising a bundling module to identify an entity, and to notify the identified entity of an opportunity to create a customized bundle, to identify a pre-created bundle, or both, the notification to include information selected from one or more of: a commodity offered by the identified entity that meets the user-selected preference criterion, one or more user-selected commodity type-criteria, and information obtained by data mining techniques.

9. The network-accessible compute node of claim 8 wherein the identified entity includes a given commodity provider, a resource for a group of commodity providers, or both, the bundling module to identify the entity in response to one or more of a user-selected customization criterion, an indicator associated with the identified one or more images of, and entity-expressed interest in bundling opportunities.

10. The network-accessible compute node of claim 7 further comprising a negotiation module to receive a counteroffer to an originally offered price, determine if the counteroffer is an acceptable counteroffer, and if not, determine if a the originally offered price can be discounted to a price that is greater than the counteroffer.

11. At least one non-transitory machine accessible storage medium having instructions stored thereon, the instructions, when executed on a machine, cause the machine to:
learn to recognize a pattern from one or more reference images, the pattern associated with a user-selected preference criteria;
access a remote storage storing a plurality of images of commodities;
in response to recognizing the pattern in one or more images of commodities of the plurality of images of commodities, identify the one or more images of commodities as meeting the user-selected preference criteria;
receive a user selection of a collection comprising two or more commodities, together with one or more preferences; and
locate the collection at a single provider that can provide the two or more commodities having the specified preferences.

12. The at least one machine accessible storage medium of claim 11 further comprising instructions that cause the machine to, identify a good or a service associated with a user-selected commodity-type criteria and a preference associated with the user-selected preference criteria, the commodity-type criteria to be selected from at least one of, clothing, a type of garment, furniture, a type of furniture, home décor, yard décor, a building, a type of building, a single-family home, electronics, a type of electronics, a plant, a type of plant, a water feature, landscaping services, a nail salon, a nail technician, a hair salon, a hair stylist, a tanning salon, a bridal salon, lawn care services, real estate, a real estate agent, a restaurant, a fitness facility, a fitness professional, and interior decorators, and the preference criteria selected from at least one of, a universal user-defined preference, a commodity-specific user-defined preference, a color, a pattern, a material, a size, a purpose, a type of exercise, modern, eclectic, ethnic, traditional, country, western, cottage, Victorian, Elizabethan, a particular era, plantation, ranch, beach, gothic, nouveau, a celebrity to emulate, a type of architectural style, brick, wood, stucco, columns, porch, a number of rooms, a type of room, square feet, a type of genre, rock, family, adventure, an age, child, adult, tween, teen, senior, a type of restaurant, fast food, family style, pizzeria, burgers, pub, fine dining, a type of cuisine, a type of salon services, a type of hair cut, a permanent, straitening, a blow-dry, highlights, a type of electronics, a smartphone, an ultrabook, a laptop, a desktop, a printer, a router, a specification, vintage, a type of processor type, curly, straight, mountain, 3-dimensional, casual, tropical, trendy, sporty, a country, a land mass, and a geographical region.

13. The at least one machine accessible storage medium of claim 12 further comprising instructions that cause the machine to, in response to the identification of the preference associated with the user-selected preference criteria, refer to the one or more reference images to learn, update learning, or remember the pattern associated with the user-selected preference criteria and the identified preference.

14. The at least one machine accessible storage medium of claim 11 further comprising instructions that cause the machine to, learn to recognize plural patterns from plural reference images using a pattern recognition algorithm, the machine to learn to recognize the plural patterns during periods of low machine usage.

15. The at least one machine accessible storage medium of claim 11 further comprising instructions that cause the machine to learn to recognize the pattern from the one or more reference images, which depict a user-designated personal preference.

16. The at least one machine accessible storage medium of claim 11 further comprising instructions that cause the machine to process a transaction relating to one or more of a purchase of a particular commodity, a purchase of a coupon for a particular commodity, a purchase of a voucher for a particular commodity, a partial payment for a particular commodity, a purchase of a bundle of commodities, a purchase of a collection of commodities, and a purchase of one or more commodities at a discounted price.

17. The at least one machine accessible storage medium of claim 11 further comprising instructions that cause the machine to, in response to a user-selected collection criteria create a collection of at least two commodities, one of the at least two commodities in the collection depicted in the one or more images identified from the plurality of images, the other of the at least two commodities in the collection depicted in the one or more images identified from the plurality of images or depicted in an image supplied by the user.

18. The at least one machine accessible storage medium of claim 11 further comprising instructions that cause the machine to take one or more actions selected from the group consisting of place a particular commodity on hold, schedule an appointment, add a scheduled appointment to a calendar, make a reservation, add a confirmed reservation to a calendar, request a sample, place a particular commodity on layaway, and enable the user to virtually or physically try on a commodity.

19. The at least one machine accessible storage medium of claim 11 further comprising instructions that cause the machine to:
determine whether a commodity depicted in the identified one or more images is a candidate for bundling;
in response to determining that the commodity is a candidate for bundling, notify a provider, a multi-provider resource, or both, of the opportunity to create or identify a bundle of commodities including the candidate commodity; and
in response to receiving information about a created or identified bundle of commodities from the provider, the multi-provider resource, or both, communicate the information about the created or identified bundle to an electronic device associated with the user.

20. The at least one machine accessible storage medium of claim 11 further comprising instructions that cause the machine to:
send information about a particular commodity depicted in the identified one or more images to an electronic device associated with the user, the information to include an original purchase price for the particular commodity;
in response to receiving a counteroffer to the original purchase price, determine whether the counteroffer is acceptable;
in response to a determination that the counteroffer is not acceptable, determine whether the original purchase price can be discounted to a price between the original purchase price and the counteroffer; and
in response to a determination that the original purchase price can be discounted send the discounted price to the electronic device, otherwise resend the original purchase price.
